(19) United States
(12) Patent Application Publication
(10) Pub. No.: US 2026/0261035 A1
(43) Pub. Date: Sep. 3, 2026

(54) TERMINAL ANTENNA

(71) Applicant: HONOR DEVICE CO., LTD., Shenzhen (CN)

(72) Inventors: Dawei ZHOU, Shenzhen (CN); Yuanpeng LI, Shenzhen (CN)

(21) Appl. No.: 18/881,666

(22) PCT Filed: Sep. 5, 2023
(86) PCT No.: PCT/CN2023/116998

§ 371 Date: Jan. 6, 2025

(30) Foreign Application Priority Data
Dec. 26, 2022 (CN) 202211676195.2

(51) Int. Cl. H01Q 1/24; H01Q 1/38; H01Q 1/50; H01Q 9/04

(52) U.S. Cl. CPC H01Q 1/243; H01Q 1/38; H01Q 1/50; H01Q 9/045

(57) ABSTRACT

Embodiments of this application disclose a terminal antenna, and relate to the field of antenna technologies. Through a design of the present invention, high radiation performance is implemented when a length of a radiator is less than ½ wavelength. In a specific solution, the antenna includes a first radiator, a length of the first radiator is less than a first value, and the first value corresponds to ½ wavelength of an operating frequency of the antenna. A first feed point and a second feed point are disposed at two ends of the first radiator respectively, the first feed point and the second feed point are connected to two signal output ends of a common mode feed structure respectively, the two signal output ends have a same polarity, and the two signals are signals of equal amplitude and in phase.

### TECHNICAL FIELD

This application claims priority to Chinese Patent Application No. 202211676195.2, filed with the China National Intellectual Property Administration on Dec. 26, 2022 and entitled “TERMINAL ANTENNA”, which is incorporated herein by reference in its entirety.

This application relates to the field of antenna technologies, and in particular, to a terminal antenna.

### BACKGROUND

An electronic device may provide a wireless communication function through an antenna disposed therein. With the development of the electronic device, quality requirements of wireless communication are increasingly high. In addition, an integration level of the electronic device is increasingly high. Consequently, a design space for the antenna is increasingly limited. Therefore, the antenna in the electronic device needs to provide better radiation performance and have a smaller size, to implement high-quality wireless communication of the electronic device in a limited space.

### SUMMARY

Embodiments of this application provide a terminal antenna. In this antenna solution, through an antenna design of the present invention, high radiation performance is implemented when a length of a radiator is less than ½ wavelength.

To achieve the foregoing objective, the following technical solutions are used in embodiments of this application.

According to a first aspect, a terminal antenna is provided, and the antenna is used in an electronic device. The antenna includes a first radiator, a length of the first radiator is less than a first value, and the first value corresponds to ½ wavelength of an operating frequency of the antenna. A first feed point and a second feed point are disposed at two ends of the first radiator respectively, the first feed point and the second feed point are connected to two signal output ends of a common mode feed structure respectively, the two signal output ends have a same polarity, and the two signals are signals of equal amplitude and in phase.

Based on this solution, low-impedance common mode feed is performed on both ends of the radiator to excite a radiator with a length less than ½ wavelength to radiate. An excitation solution of the antenna is significantly different from an existing design. Therefore, a feed form of the antenna is enriched. The length of the radiator of this solution is smaller than a conventional ½ wavelength, so that the radiator also has a miniaturization advantage. For example, when the antenna is in operation, a maximum electric field amplitude difference between the radiator and a reference ground decreases corresponding to the length of the radiator. In this way, better radiation performance can be provided.

Optionally, the length of the first radiator is less than or equal to ¼ wavelength of the operating frequency.

Optionally, the length of the first radiator is less than or equal to ⅛ wavelength of the operating frequency.

For example, when the length of the first radiator is less than ¼ wavelength, or less than ⅛ wavelength, when the terminal antenna is in operation, performance may be further improved. When the length of the radiator is smaller, the maximum electric field amplitude difference is smaller, and the radiation performance is correspondingly improved.

Optionally, the common mode feed structure includes a first feed source and a second feed source, a first electrode of the first feed source is coupled to the first feed point, and a first electrode of the second feed source is coupled to the second feed point. The first electrode is a positive electrode, or the first electrode is a negative electrode.

Optionally, the common mode feed structure includes a third feed source, and a first electrode of the third feed source is coupled to the first feed point and the second feed point respectively.

The solution provides implementations of two different common mode feed structures.

Optionally, a feed signal outputted by the common mode feed structure and then inputted to the first radiator has a low-impedance port characteristic.

Optionally, a match circuit is disposed between the common mode feed structure and the first radiator, and the match circuit is configured to adjust an impedance of the feed signal outputted by the common mode feed structure to the low-impedance port characteristic.

It should be noted that, in some implementations, if the feed signal is a signal in a low-impedance state, the match circuit may still be disposed between the feed source and the radiator, and is configured for further fine tuning of the port impedance.

Optionally, when the antenna is in operation, the antenna operates in a 0.5 time wavelength mode.

Optionally, when the antenna is in operation, the maximum electric field amplitude difference between the first radiator and the reference ground is less than a second value, and the second value is the maximum electric field amplitude difference between the first radiator and the reference ground corresponding to a case when the length of the first radiator is replaced with the first value.

Optionally, the first radiator is in a stripe shape, and a straight line on which a long side of the first radiator is located is parallel to the reference ground.

Optionally, the first radiator includes a second part, a first part, and a third part that are connected in sequence, the second part is perpendicular to the reference ground, the third part is perpendicular to the reference ground, and the first part is disposed between the second part and the third part.

Optionally, a first slot is disposed at a middle position of the first radiator, and the first slot divides the first radiator into two parts that are not connected to each other.

In this way, two possible variations are provided.

An optimization design example of the solution is provided in the following examples.

Optionally, the first radiator is divided into at least two radiation units by at least one second slot Two ends of each radiation unit are connected to the two signal output ends of the common mode feed structure respectively. Alternatively, one end of the any one or more first radiation units is grounded through an inductance, another end of the first radiation unit is coupled to the feed source, and the first radiation unit is included in the at least two radiation units. When a quantity of first radiation units is less than the at least two radiation units, two ends of a second radiation unit are connected to the two signal output ends of the common mode feed structure respectively, and the second radiation unit corresponds to each radiation unit that is of the at least two radiation units and that is different from the first radiation unit.

To be specific, in some implementations, the two ends of each radiation unit may be directly coupled to the feed source. In some other implementations, one end of at least one radiation unit is grounded through the inductance.

Optionally, a size of the second slot is included in a range of [0.1 mm, 5 mm].

Optionally, at least one inductance is disposed in parallel at the first radiator. When a plurality of inductances are connected in parallel at the first radiator, at least part of the first radiator is included between any two of the inductances.

According to a second aspect, a terminal antenna is provided, and the antenna is used in an electronic device. The antenna includes a reference ground and a third slot opened on the reference ground, a length of the third slot is less than a first value, and the first value corresponds to ½ wavelength of an operating frequency of the antenna. Two ends of the third slot are a first end and a second end respectively, the first end includes a first electrical connection point and a second electrical connection point, the second end includes a third electrical connection point and a fourth electrical connection point, the first electrical connection point and the third electrical connection point are located at a same side of a long side of the third slot, and the second electrical connection point and the fourth electrical connection point are located at the other side of the long side of the third slot. A third feed source is connected between the first electrical connection point and the second electrical connection point, a fourth feed source is connected between the third electrical connection point and the fourth electrical connection point, a signal inputted into the first electrical connection point by the third feed source is a first signal, a signal inputted into the third electrical connection point by the fourth feed source is a second signal, and the first signal and the second signal are signals of equal amplitude and in phase.

Optionally, the length of the third slot is less than or equal to ¼ wavelength of the operating frequency.

Optionally, the length of the third slot is less than or equal to ⅛ wavelength of the operating frequency.

Optionally, the second electrical connection point and the fourth electrical connection point are reference grounds of the third feed source and the fourth feed source respectively.

The second aspect provides an implementation of a slot antenna. In other words, the common mode feed structure disposed at both ends provided in this application can be applied to a line antenna or the slot antenna.

According to a third aspect, a terminal antenna is provided. The antenna includes a first radiator, a length of the first radiator is a first value, and the first value corresponds to ½ wavelength of an operating frequency of the antenna. A first feed point and a second feed point are disposed at two ends of the first radiator respectively, the first feed point and the second feed point are connected to two signal output ends of a common mode feed structure respectively, the two signal output ends have a same polarity, and the two signals are signals of equal amplitude and in phase.

Optionally, a feed signal outputted by the common mode feed structure and then inputted to the first radiator has a low-impedance port characteristic.

In an example of the third aspect, a length of the antenna may correspond to ½ wavelength of an operating frequency. The various optional designs of the first aspect or the second aspect may also be applied to the third aspect, and effects are similar.

According to a fourth aspect, an electronic device is provided. The electronic device is provided with the terminal antenna as provided in any one of the first aspect and the possible implementations thereof, or the terminal antenna as provided in the second aspect, or the terminal antenna as provided in the third aspect and the possible implementations thereof, or the terminal antenna as provided in the fourth aspect and the possible implementations thereof. When transmitting or receiving a signal, the electronic device transmits or receives the signal through the terminal antenna.

It should be understood that, technical features of the technical solution provided in the foregoing fourth aspect may correspond to the solutions provided in the first aspect to the third aspect and the possible designs thereof. Therefore, beneficial effects that can be achieved are similar, and details are not described herein again.

### BRIEF DESCRIPTION OF DRAWINGS

FIG. 1 is a schematic diagram of an antenna link in an electronic device;

FIG. 2A is a schematic diagram of an antenna solution;

FIG. 2B is a schematic diagram of an antenna solution;

FIG. 2C is a schematic diagram of an antenna solution;

FIG. 3 is a schematic diagram of current distribution on an antenna;

FIG. 4 is a schematic diagram of electric field distribution between an antenna and a reference ground;

FIG. 5 is a schematic diagram of an antenna solution;

FIG. 6A is a schematic diagram of an antenna solution according to an embodiment of this application;

FIG. 6B is a schematic diagram of an antenna solution according to an embodiment of this application;

FIG. 7 is a schematic diagram of an antenna solution according to an embodiment of this application;

FIG. 8 is a schematic diagram of an antenna solution according to an embodiment of this application;

FIG. 9 is a schematic diagram of a simulation model of an antenna solution according to an embodiment of this application;

FIG. 10 is a schematic diagram of a simulation of an S-parameter according to an embodiment of this application;

FIG. 11 is a schematic diagram of an electric field simulation according to an embodiment of this application;

FIG. 12 is a schematic diagram of a pattern simulation according to an embodiment of this application;

FIG. 13 is a schematic diagram of a simulation model of an antenna solution according to an embodiment of this application;

FIG. 14 is a schematic diagram of an antenna solution according to an embodiment of this application;

FIG. 15 is a schematic diagram of an antenna solution according to an embodiment of this application;

FIG. 16 is a schematic diagram of an antenna solution according to an embodiment of this application;

FIG. 17 is a schematic diagram of an antenna solution according to an embodiment of this application;

FIG. 18A is a schematic diagram of an antenna solution according to an embodiment of this application;

FIG. 18B is a schematic diagram of an antenna solution according to an embodiment of this application;

FIG. 19 is a schematic diagram of an antenna solution according to an embodiment of this application;

FIG. 20 is a schematic diagram of an antenna solution according to an embodiment of this application;

FIG. 21 is a schematic diagram of an antenna solution according to an embodiment of this application;

FIG. 22 is a schematic diagram of an antenna solution according to an embodiment of this application;

FIG. 23 is a schematic diagram of an antenna solution according to an embodiment of this application; and

FIG. 24 is a schematic diagram of an antenna solution according to an embodiment of this application.

### DESCRIPTION OF EMBODIMENTS

Currently, most electronic devices can provide a wireless communication function.

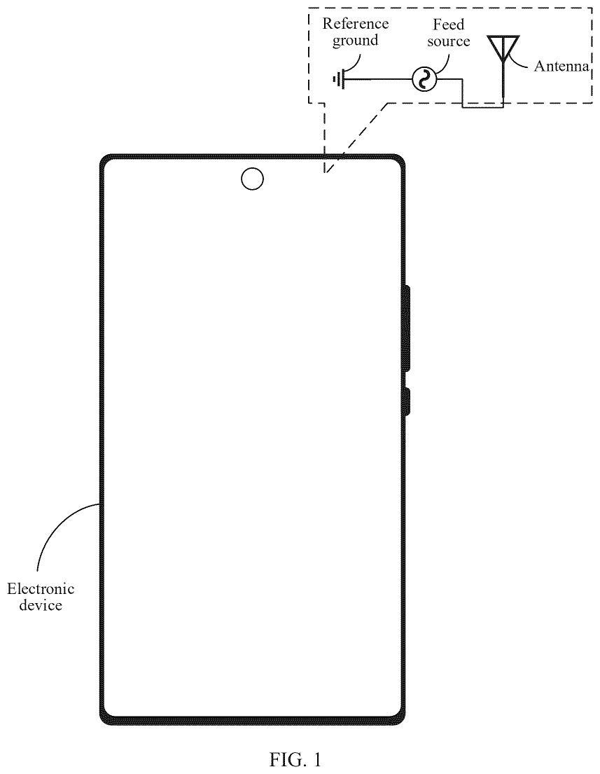

Refer to FIG. 1. In an example, the electronic device is a mobile phone. At least one antenna connected to a feed source may be disposed in the electronic device. The antenna may implement an electromagnetic wave radiation or receiving function under excitation of the feed source, so that the electronic device provides the foregoing wireless communication function.

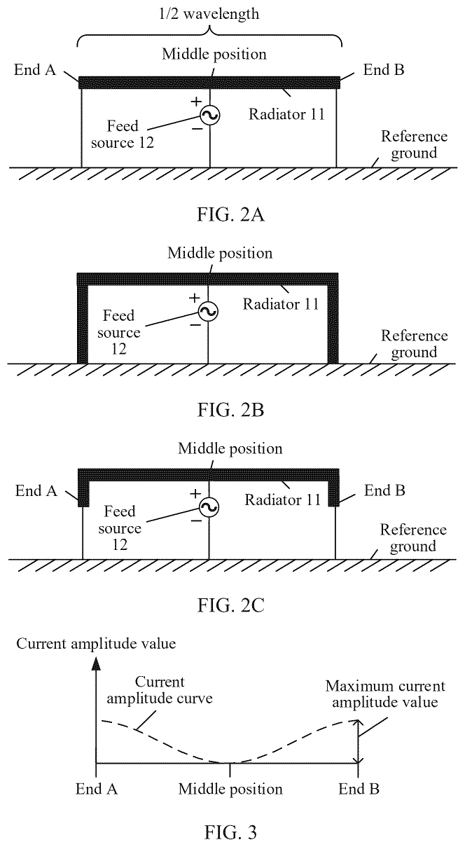

For example, FIG. 2A provides a logical schematic diagram of an antenna solution. In the example shown in FIG. 2A, the antenna may include a radiator, such as a radiator 11. In some implementations, a length of the radiator 11 may correspond to ½ wavelength of an operating frequency band. In the example shown in FIG. 2A, both ends of the radiator 11 may be grounded respectively, so that radiation is performed through an electric field distributed in a space between the radiator 11 and a reference ground.

It should be noted that, in this embodiment of this application, the correspondence between the length of the radiator and the wavelength of the operating frequency may be a correspondence after loss conversion of an electrical signal based on a metal material from which the radiator is prepared. For example, in the example shown in FIG. 2A, the length of the radiator 11 corresponding to ½ wavelength of the operating frequency may be interpreted as that an ideal size of the radiator corresponding to the radiator 11 is equal to or close to ½ wavelength of the operating frequency band. The ideal size of the radiator may be obtained based on parameters such as the length of the radiator 11, and a tangent loss angle and a dielectric constant of the metal material from which the radiator 11 is prepared.

In the example of FIG. 2A, a feed source 12 of the antenna may be disposed at a middle position of the radiator 11. For example, two ends of the feed source 12 may be connected to the radiator 11 and the reference ground respectively. For example, as shown in FIG. 2A, a positive electrode of the feed source 12 may be connected to the middle position of the radiator 11. A negative electrode of the feed source 12 may be connected to the reference ground. In addition, both ends (an end A and an end B shown in FIG. 2A) of the radiator 11 may be grounded respectively. It should be noted that, in the example of FIG. 2A, the end A and the end B of the radiator 11 may be connected to the reference ground through ground cables respectively. In some other embodiments, as shown in FIG. 2B, the radiator 11 may alternatively be bent downward at the both ends, so that the radiator is directly connected to the ground at the ends. In some other embodiments, as shown in FIG. 2C, the radiator 11 may alternatively be bent downward at the both ends, so that end surfaces of the end A and the end B are opposite to the reference ground respectively. Further, the ground cables are disposed between the end surface of the end A and the reference ground, and between the end surface of the end B and the reference ground, so that the radiator 11 is grounded. In the following examples, an example in which the radiator 11 is grounded through the solution shown in FIG. 2A is used.

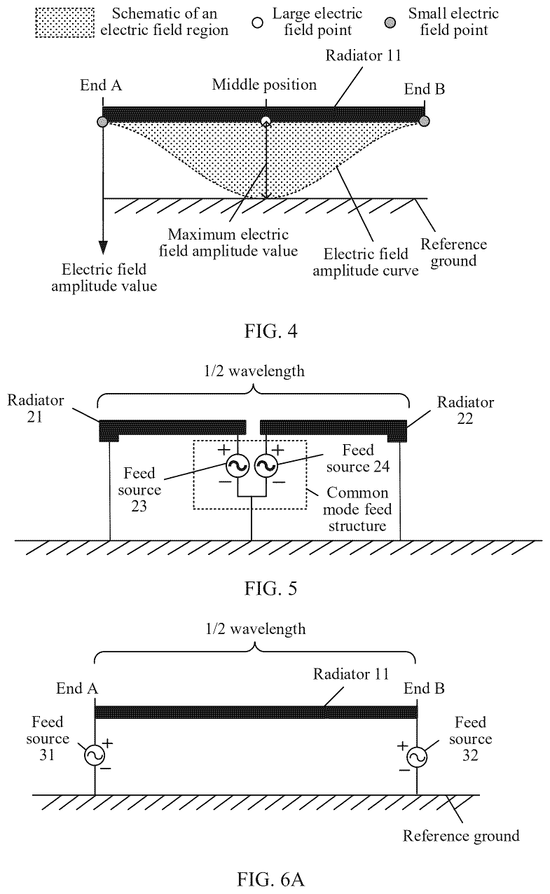

Operation characteristics of the antenna solution shown in FIG. 2A are described below with reference to FIG. 3 and FIG. 4.

For example, in some embodiments, the operation characteristics are described from a perspective of current distribution. FIG. 3 is a schematic diagram of a current amplitude curve formed by current amplitudes at different positions on the radiator 11 when the antenna shown in FIG. 2A is in operation. As shown in FIG. 3, when the antenna shown in FIG. 2A is in operation, two large current points and one small current point may be distributed on the radiator 11. The large current point may be a point with a large current amplitude. Correspondingly, the small current point may be a point with a small current amplitude.

The two large current points on the radiator 11 may be located at two ends of the radiator 11 respectively. For example, the two large current points may be located at the end A and the end B on the radiator 11 respectively. The small current point on the radiator 11 is located at the middle position of the radiator 11, that is, a position at which the feed source 12 is connected.

In some other embodiments, the operation characteristics are described from a perspective of electric field distribution. FIG. 4 is a schematic diagram of an electric field amplitude curve formed by electric field amplitudes at different positions in a region between the radiator 11 and the reference ground when the antenna shown in FIG. 2A is in operation. As shown in FIG. 4, when the antenna shown in FIG. 2A is in operation, in the region between the radiator 11 and the reference ground, a feature of an inverted bell shaped curve is shown in a direction of a long side of the radiator 11.

In a manner of describing the electric field, the electric field amplitude is projected on the radiator 11, and a point at which the electric field amplitude projected on the radiator 11 is the smallest may be referred to as a small electric field point. A point at which the electric field amplitude projected on the radiator 11 is large may be referred to as a large electric field point.

In addition, as shown in FIG. 4, the radiator 11 may include two small electric field points and one large electric field point respectively. The small electric field points may be located at both ends of the radiator 11 respectively. For example, the two small electric field points may be located at the end A and the end B of the radiator 11 respectively. Correspondingly, the large electric field point may be located at the middle position of the radiator 11, that is, the position at which the feed source 12 is connected.

It should be noted that, in a specific implementation process, because an excitation source needs to be disposed at the small current point (that is, the middle position), the feed source (such as the feed source 12) involved in the antenna shown in any one of FIG. 2A to FIG. 2C may be a feed source that can provide a feed signal in a high-impedance state, and is referred to as a high-impedance feed source for short. In this embodiment of this application, a port characteristic of the feed signal may include the high-impedance state and a low-impedance state. The high-impedance state may be an impedance state in which a port impedance is greater than 100 Ohms. For example, the port impedance in the high-impedance state may be 200 Ohms or 500 Ohms. The low-impedance state may be an impedance state in which the port impedance is less than 100 Ohms. For example, the port impedance in the low-impedance state may be 50 Ohms or 75 Ohms. A feed source that can provide a feed signal in the low-impedance state, as opposed to the high-impedance feed source, may be referred to as a low-impedance feed source.

In another implementation of the antenna structure shown in FIG. 2A, FIG. 5 is a schematic diagram of another antenna solution.

Refer to FIG. 2A. As shown in FIG. 5, an antenna radiator may include a radiator 21 and a radiator 22. The radiator 21 and the radiator 22 may correspond to ¼ wavelength of the operating frequency respectively. The radiator 21 and the radiator 22 may be separated through a slot. A width of the slot may be much less than a length of the radiator 21 or a length of the radiator 22. Therefore, when the radiator 21 and the radiator 22 are disposed at a same straight line, a total length of the antenna radiator formed by the radiator 21 and the radiator 22 may be close to ½ wavelength of the operating frequency band. From another perspective, the radiator 21 and the radiator 22 may alternatively be disposed at the middle position of the radiator 11 as shown in FIG. 2A. A slot is disposed between the radiator 21 and the radiator 22, and the radiator 21 and the radiator 22 are disposed side by side.

In the example shown in FIG. 5, ends close to each other of the radiator 21 and the radiator 22 may be connected to the feed source respectively. For example, an end of the radiator 21 close to the radiator 22 may be connected to a feed source 23. An end of the radiator 22 close to the radiator 21 may be connected to a feed source 24. Both the feed source 23 and the feed source 24 may be high-impedance feed sources.

In this example, ends that are of the feed source 23 and the feed source 24 and that are connected to the radiators may have a same polarity. For example, a positive electrode of the feed source 23 may be connected to the radiator 21, and is close to the end of the radiator 22. A positive electrode of the feed source 24 may be connected to the radiator 22, and is close to the end of the radiator 21. For another example, a negative electrode of the feed source 23 may be connected to the radiator 21, and is close to the end of the radiator 22. A negative electrode of the feed source 24 may be connected to the radiator 22, and is close to the end of the radiator 21.

In this way, when the antenna shown in FIG. 5 is in operation, the feed source 23 and the feed source 24 can feed feed signals of equal amplitude and in phase to the radiator 21 and the radiator 22 respectively. The feed source 23 and the feed source 24 that can provide the feed signals of equal amplitude and in phase may jointly form a common mode (Common Mode, CM) feed structure.

It may be understood that, when the antenna having the structure shown in FIG. 5 is in operation, a distribution feature of an electric parameter (for example, a current or an electric field) shown in FIG. 3 or FIG. 4 can also be obtained.

For example, from a current perspective, when the antenna shown in FIG. 5 is in operation, the ends close to each other of the radiator 21 and the radiator 22 may be small current points. In other words, a position at which the feed source 23 and the feed source 24 are connected is the small current point. Correspondingly, an end of the radiator 21 away from the radiator 22 and an end of the radiator 22 away from the radiator 21 may be two large current points.

From a perspective of an electric field, when the antenna shown in FIG. 5 is in operation, the ends close to each other of the radiator 21 and the radiator 22 may be large electric field points. Correspondingly, the ends away from each other on the radiator 21 and the radiator 22 may be small electric field points.

Optionally, in some specific implementations of the antenna solution shown in FIG. 2A or FIG. 5, a match circuit may further be disposed between the feed source and the radiator, to facilitate port impedance adjustment of the feed signal fed to the radiator. In this way, there is no energy loss caused by an apparent mismatch at the port at which the feed signal is fed to the radiator.

It may be understood that, in the solution examples in FIG. 2A to FIG. 5, there are specific requirements on the position of the feed source and the impedance characteristic of the signal that the feed source can provide. In this way, a large quantity of limitations are imposed on conditions under which the antenna is disposed in a device.

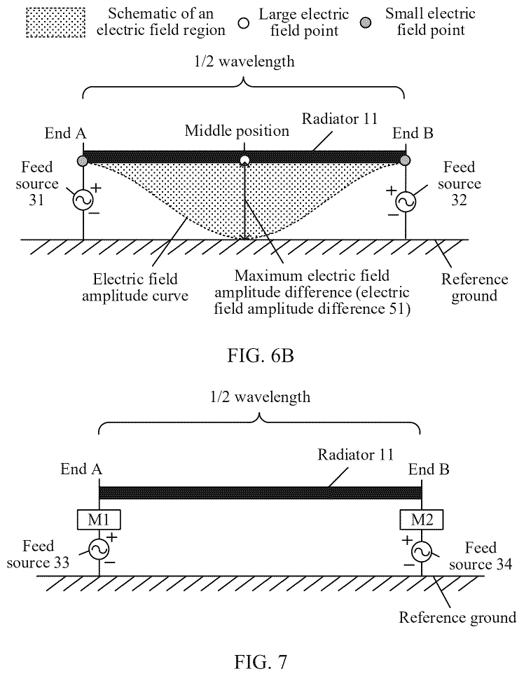

In this case, different from the solution implementation shown in FIG. 5, embodiments of this application provide a terminal antenna solution. FIG. 6A is an antenna structure embodiment of the invention of this application. A radiation effect similar to that in any one of FIG. 2A to FIG. 2C or FIG. 5 may be implemented by connecting a common mode feed structure at both ends of the radiators. In this way, rich feed forms of the antenna can be provided for selection when the same or better radiation performance is provided.

For example, the feed form provided in embodiments of this application may be used in the foregoing radiator disposing shown in FIG. 2A, FIG. 2B, FIG. 2C, or FIG. 5. Therefore, the antenna is excited to operate in the state shown in FIG. 3 or FIG. 4.

An example in which the common mode feed structure provided in this embodiment of this application is disposed at the radiator 11 shown in FIG. 2A is used.

As shown in FIG. 6A, with reference to the foregoing descriptions, the length of the radiator 11 may correspond to ½ wavelength of the operating frequency band. In some embodiments, the radiator 11 may be in an elongated shape, and the two ends are the end A and the end B respectively.

In this example, the common mode feed structure may be formed by a feed source 31 and a feed source 32 that can provide the feed signals of equal amplitude and in phase. The feed source 31 and the feed source 32 may be disposed at the two ends of the radiator 11 respectively. For example, the feed source 31 may be disposed at the end A of the radiator 11, and the feed source 32 may be disposed at the end B of the radiator 11.

It should be noted that, different from the foregoing disposing of the high-impedance feed source (for example, the feed source 23 and the feed source 24, or the feed source 12), in the example of FIG. 6A, the feed signal outputted by the common mode feed structure formed by the feed source 31 and the feed source 32 and inputted to the radiator 11 may be in the low-impedance state.

In this embodiment of this application, the low-impedance state of the feed signal may be implemented in any one of the following manners.

The low-impedance state is obtained through a signal source having a low-impedance port characteristic.

For example, when both the feed source 31 and the feed source 32 are low-impedance feed sources, the common mode feed structure formed by the feed source 31 and the feed source 32 can directly feed the feed signal in the low-impedance state to the radiator 11.

2. A match circuit is disposed between the signal source of the high-impedance port characteristic and the radiator, and the port characteristic of the feed signal sent by the high-impedance feed source is matched to the low-impedance state through the match circuit.

In the example in FIG. 6A, an example in which both the feed source 31 and the feed source 32 that schematically form the common mode feed structure are the low-impedance feed sources is used for description. Based on the disposing of the common mode feed structure shown in FIG. 6A, when feeding is performed on the both ends of the radiator 11. the antenna can also be excited to operate in a fundamental mode (such as ½ wavelength mode).

For example, FIG. 6B is a schematic diagram of distribution of the electric field between the radiator 11 and the reference ground when the antenna is in operation. Similar to the foregoing descriptions of FIG. 4, when the antenna solution shown in FIG. 6A is in operation, two small electric field points and one large electric field point may also be distributed on the radiator 11. The small electric field points may be located at the end A that is connected to the common mode feed structure and the end B respectively. The large electric field point may be located at the middle position of the radiator 11.

For ease of subsequent descriptions, as shown in FIG. 6B, when the length of the radiator 11 corresponds to ½ wavelength of an operation wavelength, a maximum electric field amplitude difference corresponding to the large electric field point and the small electric field point is denoted as an electric field amplitude difference 51.

FIG. 7 is an implementation in which high-impedance feed sources are disposed at both ends of the radiator 11 for feeding excitation. In this example, the high-impedance feed sources that form the common mode feed structure may include a feed source 33 and a feed source 34. The feed source 33 may be connected to the end A of the radiator 11 through a match circuit M1. The feed source 34 may be connected to the end B of the radiator 11 through a match circuit M2.

The match circuit M1 may be configured to: modulate a port impedance of a feed signal in the high-impedance state outputted by the feed source 33 into the low-impedance state, and feed the feed signal in the low-impedance state to the end A of the radiator 11. The match circuit M2 may be configured to: modulate a port impedance of a feed signal in the high-impedance state outputted by the feed source 34 into the low-impedance state, and feed the feed signal in the low-impedance state to the end B of the radiator 11. Therefore, the radiator 11 is excited from the both ends.

It may be understood that, in the example shown in FIG. 7, the match circuit M1 and the match circuit M2 may be further configured to match and adjust a signal that is fed to the radiator, so that an impedance of the signal can be matched with an impedance in the operating frequency band. Therefore, less reflection of the operating frequency band at the port is implemented, and efficiency of signal transmission is improved. For example, an example in which the impedance in the operating frequency band is 50 Ohms is used. When matching is performed through the match circuit M1 and the match circuit M2, the impedance of the feed signal in the operating frequency band can be modulated to approximate or equal to 50 Ohms from the high-impedance state of the feed source, so that transmission can be performed more efficiently at the port. In some other embodiments, the match circuit may be further configured to tune an electrical length of the radiator, to adjust a frequency position of excitation resonance on the radiator.

In addition, in some other embodiments of this application, the match circuit M1 and the match circuit M2 shown in FIG. 7 may alternatively be disposed in a scenario of excitation by using the low-impedance feed source. In this way, values of capacitances/inductances in the match circuit M1 and the match circuit M2 are adjusted to implement an effect that the impedance of the feed signal matches the impedance in the operating frequency band. In some other embodiments, the match circuit may be further configured to tune the electrical length of the radiator, to adjust the frequency position of the excitation resonance on the radiator.

It is clear that, when the common mode feed structure includes both one low-impedance feed source and one high-impedance feed source, on a link corresponding to the high-impedance feed source, refer to the foregoing disposing example of the feed source 33 or the feed source 34 in FIG. 7. The match circuit is disposed at the link corresponding to the high-impedance feed source, to adjust the feed signal in the high-impedance state, so that the feed signal in the low-impedance state is obtained, and the feed signal is fed to the radiator.

The foregoing FIG. 6A and FIG. 7 provide detailed descriptions of specific implementations of the common mode feed structure disposed at the both ends of the radiator according to embodiments of this application. It may be understood that, in the foregoing examples, an example in which the antenna radiator includes the radiator 11 is used for description. In some other implementations, the radiator 11 may alternatively be transformed into radiator forms shown in FIG. 2B or FIG. 2C. or a combination of the radiator 21 and the radiator 22 shown in FIG. 5, or the radiator 11 may alternatively be transformed into another radiator structure. A person skilled in the art should understand that the antenna solution excited by using the common mode feed structure shown in FIG. 6A or FIG. 7 or a similar structure shall fall within the scope of embodiments of this application.

In the following descriptions, based on the solution shown in FIG. 6A, the length of the radiator is further adjusted, to obtain better radiation performance. It may be understood that, the following solution implementations may also be applied to variations such as those in FIG. 7 or other solution implementations, and beneficial effects can be obtained similarly. Details are not described again.

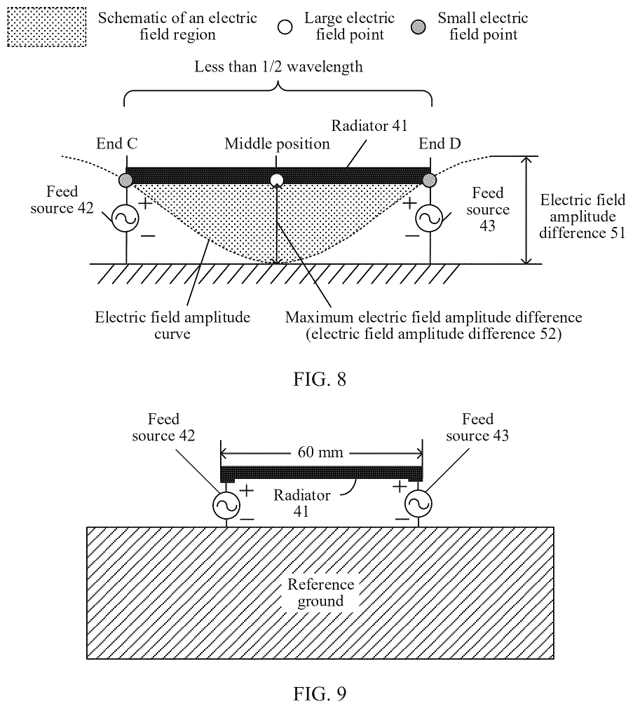

For example, FIG. 8 is a schematic diagram of another terminal antenna according to an embodiment of this application.

In an example of FIG. 8, an antenna radiator may include a radiator 41. A length of the radiator 41 may be less than ½ wavelength of an operating frequency band.

In the solution shown in FIG. 8, the common mode feed structure shown in FIG. 6A or FIG. 7 may be used as the feeding manner.

For example, the common mode feed structure may be connected to two ends (for example, an end C and an end D) of the radiator 41 respectively. For example, the end C may be connected to a feed source 42, and the end D may be connected to a feed source 43. It may be understood that, with reference to the descriptions of FIG. 2A and FIG. 2C, in some other embodiments, end surfaces of the two ends of the radiator 41 may alternatively be downward and opposite to a reference ground. Therefore, the feed source 42 and the feed source 43 are connected between the two end surfaces and the reference ground for excitation.

In this example, an example in which the feed source 42 and the feed source 43 both are low-impedance feed sources is used. Similar to the example of FIG. 6A, the feed source 42 and the feed source 43 may form a common mode feed structure. The common mode feed structure may be configured to feed the radiator 41 with feed signals of equal amplitude and in phase. It may be understood that, in some other examples, when the common mode feed structure includes a high-impedance feed source, the common mode feed structure may be disposed with reference to the solution descriptions of FIG. 7. In addition, in some embodiments, corresponding match circuits may be disposed at a link corresponding to the feed source 42 and a link corresponding to the feed source 43 respectively, and are configured for port matching, to reduce port reflection. For a corresponding implementation, refer to the foregoing example of FIG. 7. Details are not described herein again. In some other embodiments, the match circuit may be further configured to tune an electrical length of the radiator, to adjust a frequency position of excitation resonance on the radiator.

An example in which the antenna shown in FIG. 8 operates in a fundamental mode is used as an example. In this case, from a current distribution perspective, a point with a minimum current amplitude may be a middle position of the radiator, and points with maximum current amplitudes may be at both ends of the radiator. In other words, the radiator 41 may have a small current point located at the middle position and large current points located at the end C and the end D respectively.

With reference to comparison between FIG. 3 and FIG. 4, it is well known in the art that, during antenna resonance, a large current corresponds to a small electric field amplitude in a nearby region, and a small current corresponds to a large electric field amplitude in a nearby region. In this case, in a region between the radiator 41 and the reference ground, an amplitude of an electric field near the small current point at the middle position of the radiator 41 is large, and corresponds to a large electric field point of the radiator 41 between the middle position and the reference ground. Similarly, an electric field amplitude near a large current point of the end C and the end D of the radiator 41 is small, and corresponds to a small electric field point between two end positions of the radiator 41 and the reference ground. Different from the antenna shown in FIG. 6A in which the length of the radiator corresponds to ½ wavelength, the length of the antenna radiator 41 shown in FIG. 8 is short, so that the electric field amplitude near the large electric field point decreases less compared with a maximum electric field amplitude difference at the two ends. In a preferred embodiment, when the length of the radiator is less than ¼ wavelength, a change amount of the large electric field amplitude point in the middle of the radiator is small compared with small electric field amplitude points at the two ends. In other words, reduction of the maximum electric field amplitude difference to a certain extent can be considered as approximately uniform electric field distribution.

From another perspective, in an operating state of the fundamental mode, regardless of the length of the radiator, in a space between the radiator and the reference ground, electric field strength distribution satisfies a feature of an inverted bell shaped curve. In this case, in the solution example shown in FIG. 8, as the length of the radiator is less than ½ wavelength of the operating frequency band, electric field distribution corresponding to the reference ground moves upward, and the point with the maximum electric field amplitude shrinks toward the radiator (that is, the maximum electric field amplitude difference decreases).

In this case, in the solution implementation shown in FIG. 8, a difference between the maximum electric field amplitude near the middle position and a minimum electric field amplitude at the end is smaller than that in the solution example shown in FIG. 6A.

For example, in the solution shown in FIG. 8, an example in which the maximum electric field amplitude difference is denoted as an electric field amplitude difference 52 is used. In this case, because the length of the radiator 41 is less than ½ wavelength, the length of the radiator 11 shown in FIG. 6A is equal to ½ wavelength (that is, corresponds to ½ wavelength of the operating frequency band). Therefore, the electric field amplitude difference 52 in FIG. 8 may be smaller than the electric field amplitude difference 51 in FIG. 6A.

It may be understood that, in a radiation process of the antenna, a larger electric field amplitude difference corresponds to a larger electric field strength difference at different positions in a space around the radiator. Consequently, radiation performance is poor at a position with a weak electric field. Therefore, overall radiation performance of the antenna is poor. In addition, when radiation power of the antenna is unchanged, energy is more concentrated toward a middle position with a larger electric field amplitude. Therefore, an antenna radiation hotspot is caused to be convex, and a SAR value is caused to deteriorate.

Correspondingly, a smaller electric field amplitude difference corresponds to a smaller electric field strength difference at the different positions in the space around the radiator. In this case, the radiation performance at the position with the weak electric field does not significantly decrease compared with radiation performance at a position with a strong electric field. Therefore, in comparison with a case in which the electric field amplitude difference is large, in this case, the overall radiation performance of the antenna can be improved. In addition, when the antenna radiation power is unchanged, a difference between positions of the electric field in the space is small. Therefore, the antenna radiation hotspot is not significant, and the SAR value is low.

Therefore, the antenna solution shown in FIG. 8 in which the length of the radiator is less than ½ wavelength, and the common mode feed structure is disposed at the both ends can obtain better radiation performance and a lower SAR than the antenna solution shown in FIG. 6A in which the radiator corresponds to ½ wavelength.

Refer to the foregoing descriptions shown in FIG. 8. When the length of the radiator is smaller, an electric field amplitude curve moves upward from the middle position toward the radiator, and two sides are symmetrically distributed. Therefore, in this scenario, the electric field amplitude difference between the middle position and endpoint positions on the two sides is smaller. In this case, a smaller maximum electric field amplitude difference in a space near the large electric field point and the small electric field point corresponds to a smaller intensity distribution difference of the electric field at various positions between the radiator and the reference ground, and is more beneficial for antenna radiation.

In some embodiments of this application, the length of the radiator 41 shown in FIG. 8 may be less than ¼ wavelength of the operating frequency band. In this case, a difference between electric field strength near the two ends (that is, the small electric field points) of the radiator 41 and electric field strength near the middle position (that is, the large electric field point) of the radiator 41 is small. Approximately, it may be considered that intensity distribution of the electric field between the radiator and the reference ground tends to be uniform. In this way, problems of poor radiation performance caused by a significant difference in intensity distribution of an electric field at various positions and a high SAR value can be better avoided.

For example, the following describes, with reference to a specific simulation schematic, an antenna solution provided in embodiments of this application in which a size of the radiator is less than ½ wavelength and is fed through the common mode feed structure disposed at the both ends of the radiator.

For example, FIG. 9 is a schematic diagram of a simulation model of an antenna solution according to an embodiment of this application. In this example, the antenna may include one radiator 41. A length of the radiator 41 may be less than ½ wavelength of an operating frequency band. Two end surfaces of the radiator 41 may face a reference ground respectively. A common mode feed structure may be connected between the end surfaces of the radiator and the reference ground.

In this example, an example in which the operating frequency band is higher than 700 MHz (such as 800 MHz), a dielectric constant (Dielectric constant, DK) corresponding to the antenna material is 3.2, and a dissipation factor (Dissipation factor, DF) corresponding to an antenna material is 0.01 is used. In this case, a size of ½ wavelength corresponding to the operating frequency band (such as 800 MHz) may be approximate to 120 mm based on the antenna disposed based on the foregoing materials. In contrast, in this example, the length of the radiator 41 may be less than 120 mm. For example, in the following simulation, an example in which the length of the radiator 41 is equal to ¼ wavelength (such as 60 mm) of the operating frequency band is used.

As shown in FIG. 9, a feed source 42 and a feed source 43 may be disposed at two ends of the radiator 41 respectively. The feed source 42 and the feed source 43 may form the common mode feed structure. For example, a positive electrode of the feed source 42 may be coupled to one end of the radiator 41, and a negative electrode of the feed source 42 may be grounded. A positive electrode of the feed source 43 may be coupled to another end of the radiator 41, and a negative electrode of the feed source 43 may be grounded.

With reference to the foregoing descriptions of a mechanism of a feed signal, in this example, an example in which both the feed source 42 and the feed source 43 both are low-impedance feed sources is used. In some other embodiments, when at least one of the feed sources is a high-impedance feed source, a match circuit may be disposed at a corresponding path. Therefore, a feed signal in a low-impedance state is obtained, and the feed signal is fed to the radiator. For specific implementations, refer to descriptions of FIG. 6A to FIG. 8. Details are not described herein again. In addition, setting of the match circuit may alternatively be configured to accurately adjust an impedance of the feed signal to the radiator, so that the impedance of the feed signal matches an impedance in the operating frequency band (for example, both are 50 Ohms or approximate to 50 Ohms). Therefore, reflection of port energy is reduced, and energy intensity fed to the radiator is improved. In some other embodiments, the match circuit may be further configured to tune an electrical length of the radiator, to adjust a frequency position of excitation resonance on the radiator.

It may be understood that, an example in which the match circuit is disposed at a link of the feed source is used. In different scenarios, components included in the match circuit may not be the same, so that a resonance position excited on the radiator 41 can correspondingly cover operating frequency bands in different scenarios.

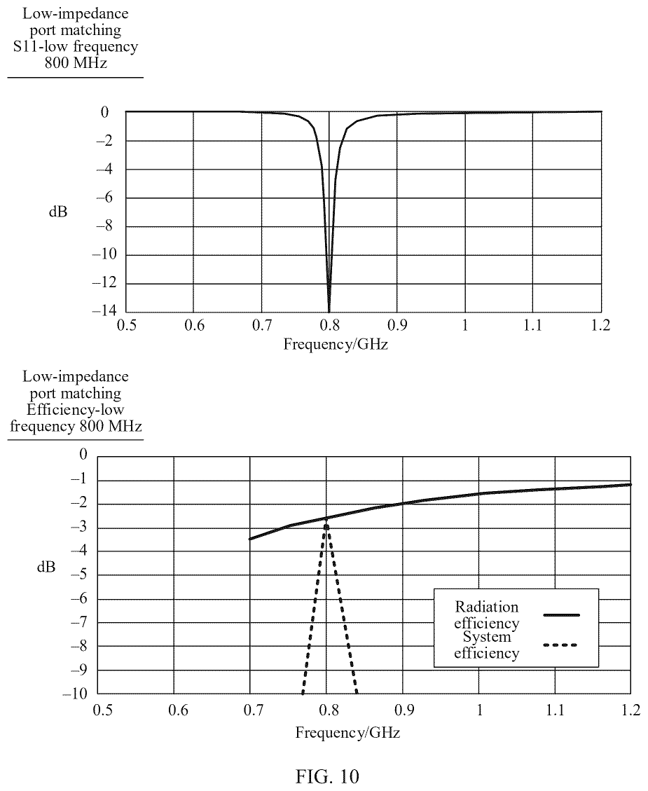

For example, FIG. 10 is a schematic diagram of a simulation of an S-parameter when an antenna model shown in FIG. 9 covers a low frequency of 800 MHz. As shown in an S11 simulation in FIG. 10, resonance generated by the antenna covers 800 MHz well, and the deepest point reaches −14 dB. It can be seen from efficiency simulation results that radiation efficiency approaches −2.5 dB at 800 MHz, and system efficiency also exceeds −3 dB at 800 MHz. In other words, when the antenna covers the low frequency of 800 MHz, the antenna can provide better radiation performance.

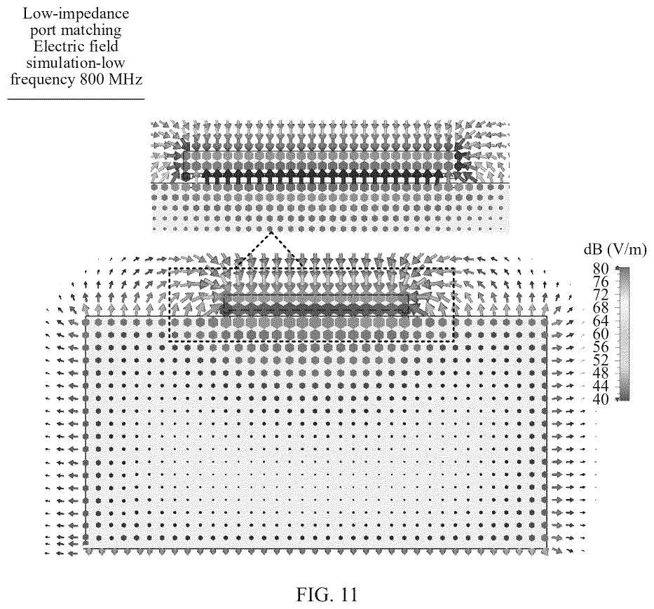

FIG. 11 is a schematic diagram of a simulation of an electric field in a space near the radiator 41 when the antenna is in operation. An arrow direction indicates a direction of an electric field at a current moment, and a darker arrow corresponds to a larger electric field amplitude. It can be seen that, through the common mode feed structure provided in embodiments of this application, an electric field in a same direction can be effectively excited in a space between the radiator and the reference ground. There is no large change in electric field strength in the space between the radiator and the reference ground. Correspondingly to the foregoing descriptions, a maximum electric field amplitude difference in the space between the radiator and the reference ground is reduced.

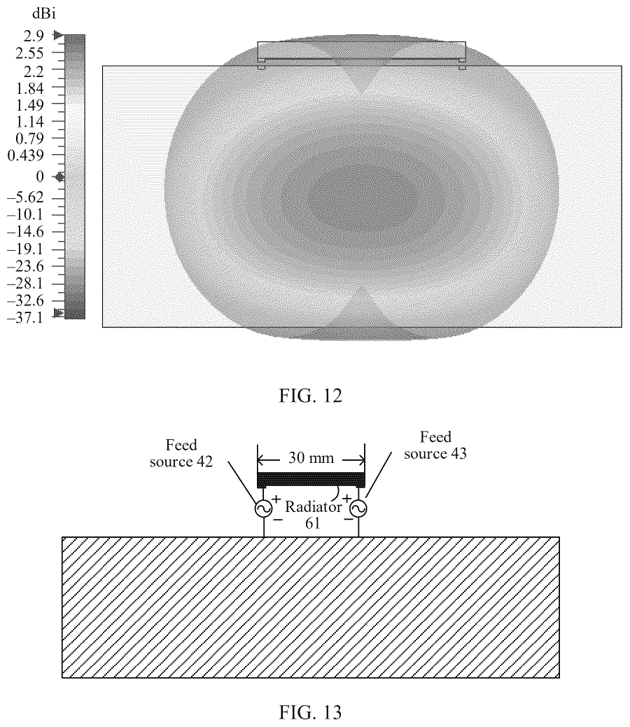

Therefore, based on the simulation results shown in FIG. 11, it can be described that the antenna solution provided in this embodiment of this application can implement energy excitation with a small amplitude difference in a space near the antenna radiator by using the common mode feed connected at both ends of the radiator (such as the radiator 41), to improve radiation performance. It can be seen from FIG. 11 that, the electric field strength between the radiator and the reference ground is approximately evenly distributed. In this scenario, the radiation performance of the antenna is improved. In addition, FIG. 12 further shows a schematic diagram of a pattern simulation of an antenna solution operating at 800 MHz according to an embodiment of this application.

In the foregoing descriptions of FIG. 9 to FIG. 12, an example in which the length of the radiator is equal to ¼ operating wavelength is used. As shown in FIG. 13, a simulation model example in which a length of a radiator 61 is 30 mm, that is, the length of the radiator is equivalent to ⅛ operating wavelength is shown. It may be understood that, in this example, the length of the radiator is further reduced, and a maximum electric field amplitude difference between the corresponding radiator and a reference ground is smaller, and electric field distribution is more uniform, so that radiation performance is better.

It should be noted that, in a specific implementation process, as the length of the radiator decreases, although the maximum electric field amplitude difference becomes smaller, radiation becomes more uniform. However, due to decreasing of an area of the radiator, a resonance bandwidth may be slightly deteriorated. Therefore, in a specific implementation process, the length of the radiator may be flexibly selected based on required radiation performance and bandwidth requirements. In some implementations, a plurality of antenna solutions with short lengths shown in FIG. 13 may be disposed to implement coverage of a same frequency band or a plurality of frequency bands, so that an overall coverage bandwidth is improved.

With reference to the foregoing descriptions of FIG. 10 to FIG. 13, a person skilled in the art should have a detailed understanding of an operation mechanism and an effect of the antenna solution (for example, the antenna solution shown in FIG. 8) provided in embodiments of this application.

Embodiments of this application further provide several examples of antenna forms different from the structure shown in FIG. 8.

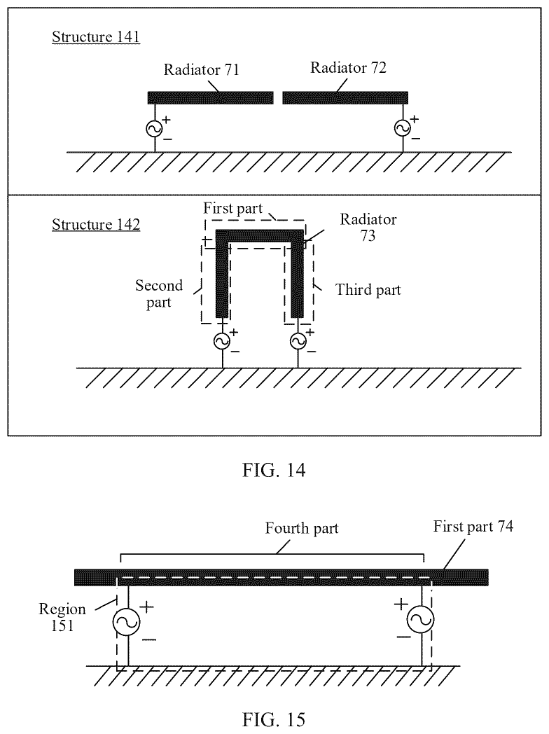

For example, FIG. 14 is an implementation of still yet another terminal antenna according to an embodiment of this application. Implementations provided in this example have a similar structural feature to the antenna shown in FIG. 8. A length of a radiator is less than ½ wavelength of an operating frequency band, and a common mode feed structure is disposed at both ends of the radiator. The common mode feed structure includes two low-impedance feed sources.

As shown in a structure 141 in FIG. 14, the radiator of the antenna in this example may include a radiator 71 and a radiator 72 that are not connected to each other. The disposing of the radiator 71 and the radiator 72 may be similar to the disposing of the radiator 21 and the radiator 22 in FIG. 5. A difference is that a total length of the radiator 71 and the radiator 72 is less than ½ wavelength of the operating frequency band. In this case, when the radiator 71 and the radiator 72 are of equal length, the length of the radiator 71 may be less than ¼ wavelength of the operating frequency band, and the length of the radiator 72 may also be less than ¼ wavelength of the operating frequency band. In some embodiments, long sides of the radiator 71 and the radiator 72 may be disposed in parallel, or disposed at a same straight line.

The antenna radiators in the structure 141 are described from another perspective, and the disposing of the radiator 71 and the radiator 72 may be understood as follows. As shown in FIG. 8, a through slot is disposed in the middle position (that is, a small electric field point) of the radiator 41, so that the radiator 41 is divided into two radiators that are not connected to each other, that is, the radiator 71 and the radiator 72.

As shown in FIG. 14, the radiator 71 and the radiator 72 may be respectively connected to the common mode feed structure for feeding. For example, common mode feed sources that can provide feed signals in low-impedance states may be connected to an end of the radiator 71 away from the radiator 72 and an end of the radiator 72 away from the radiator 71 respectively.

A structure 142 in FIG. 14 shows a schematic diagram of a structure of still another antenna. In this example, the antenna radiator may include a radiator 73. A total length of the radiator 73 may be less than ½ wavelength of an operating frequency band. The radiator 73 may be provided with two symmetrical L-shaped bent structures. The two L-shaped bent structures divide the radiator 73 into a first part parallel to (or approximately parallel to) the reference ground, a second part and a third part perpendicular (or approximately perpendicular) to the reference ground. The first part is located between the second part and the third part, and the first part, the second part, and the third part are connected end to end. One end of the radiator 73 on the second part and one end of the third part are on a same side of a straight line on a long side of the first part. For example, in an example of the structure 142, the second part and the third part may be located at a lower side of the straight line of the first part.

Low-impedance common mode feeds are fed to both ends of the radiator 73 for excitation. For example, an open end of the second part of the radiator 73 and an open end of the third part of the radiator 73 may be connected to the common mode feed structure respectively. Therefore, when the antenna is in operation, a feed signal in a low-impedance state can be connected to the common mode feed structure.

It may be understood that, the two structures shown in FIG. 14 are merely examples, and the antenna solution provided in embodiments of this application may also have other variations. In various modified structures, the antenna structure in which the length of the radiator is less than ½ wavelength of the operating frequency and the both ends are connected to the low-impedance common mode feed shall fall within the scope of the technical solutions provided in embodiments of this application.

In this way, energy distribution with a small maximum electric field amplitude difference between the antenna radiator and the reference ground can be obtained by using an antenna disposing having a size less than ½ wavelength of the operating frequency and a low-impedance common mode feed connected to both ends. so that better radiation performance is obtained.

It should be noted that, in some implementations, the low-impedance common mode feed may also be disposed at the radiator, rather than all being disposed at an end surface of the radiator. In this way, the foregoing technical effect can be obtained in the low-impedance common mode feed of the radiator and the reference ground.

For example, refer to FIG. 15. In this example, an antenna radiator may include a radiator 74. A common mode feed structure may be disposed at the radiator 74. At least one feed source in the common mode feed structure may be disposed at a non-end of the radiator 74. For example, in this example, the radiator 74 may include a fourth part. The fourth part does not include any end of the radiator 74. The common mode feed structure may be connected to both sides of the fourth part for feeding respectively. In this way, when a length of the fourth part is less than ½ wavelength of an operating frequency band, a small maximum electric field amplitude difference can be obtained in a region delimited by the fourth part of the radiator 74, a reference ground, and the common mode feed structure, so that better radiation performance in this part is obtained. Current may also be distributed on the radiator at any side of the fourth part. In this case, in some implementations, the radiator at any side of the fourth part on the radiator 74 may excite ¼ wavelength mode or another mode, to implement supplemental coverage of the operating frequency band.

It should be noted that, in the foregoing descriptions of FIG. 6A to FIG. 15, an example in which the common mode feed structure that can provide a feed signal in a low-impedance state is disposed at a line antenna for feeding is used for description. In some other embodiments, the feed structure may also be used in an implementation of a slot antenna.

For example, referring to FIG. 16, a slot 161 is disposed at the reference ground. A length Al of the slot 161 may be less than ½ wavelength of an operating frequency band. Optionally, the length Al of the slot 161 may be further less than ¼ wavelength of the operating frequency band. A common mode feed structure may be disposed at both ends of the slot 161.

In an example shown in FIG. 16, two electrical connection points may be disposed at each end of the slot 161. For example, P2 may be disposed at an upper part of a left end. P1 may be disposed at a lower part of the left end. P4 may be disposed at an upper part of a right end. P3 may be disposed at a lower part of the right end. An example in which the common mode feed structure includes two low-impedance feed sources is used. In some implementations, for any one of the two low-impedance feed sources, a positive electrode may be connected to an upper side of the slot, and a negative electrode may be connected to a lower side of the slot. In this way, feeding is performed through the common mode feed structure. For example, as shown in FIG. 16, a positive electrode of a low-impedance feed source may be connected to P2, and a negative electrode of the low-impedance feed source may be connected to P1. A positive electrode of another low-impedance feed source may be connected to P4, and a negative electrode of a low-impedance feed source may be connected to P3.

With reference to the foregoing solution example of FIG. 8, in the solution of FIG. 16, when the length of the slot 161 is equivalent to ½ wavelength, distribution of an electric field in the slot is in a feature of an inverted bell shaped curve. In this example, when the length of the slot 161 is less than ½ wavelength, a middle part of the slot remains as a large electric field point, and both ends remain as small electric field points. As the length decreases, the maximum electric field amplitude difference between the large electric field point and the small electric field point also decreases correspondingly. In this way, when the antenna shown in FIG. 16 is in operation, radiation with a small maximum electric field amplitude difference may be generated inside the slot 161, so that a better radiation effect of the slot antenna is obtained.

It may be understood that, the foregoing various variations based on the line antenna may also be used in the implementation of the slot antenna. Effects thereof can be similar, and is not described again.

In addition, an example in which the common mode feed structure includes two feed sources is used to describe the common mode feed structure in this application. In some other implementations, the common mode feed structure that can provide the feed signal in the low-impedance state in this application may alternatively include only one feed source.

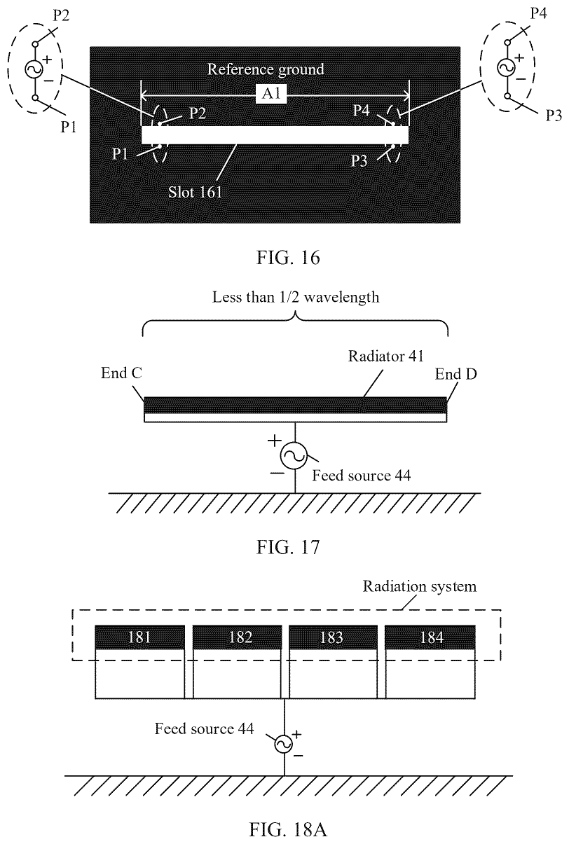

For example, the antenna solution shown in FIG. 8 is used as an example. Similar to the comparison between FIG. 2A and FIG. 5, in the antenna solution shown in FIG. 8, the common mode feed structure may also be replaced with the disposing solution shown in FIG. 17. As shown in FIG. 17, the common mode feed structure in this solution may include one feed source, such as a feed source 44.

One end of the feed source 44 may be coupled to both an end C and an end D of a radiator 41. In this way, common mode feed is implemented to both ends of the radiator 41 simultaneously. With reference to the foregoing descriptions of the low-impedance port characteristic of the feed signal, in some embodiments, the feed source 44 may be the low-impedance feed source. Therefore, feed signals outputted to the end C and the end D by using the feed source 44 may both be feed signals in the low-impedance state. In some other embodiments, the feed source 44 may be a high-impedance feed source. In this case, a low-impedance match circuit may be disposed between the feed source 44 and the end C and the end D. In this way, the feed signals fed to the end C and the end D may have the low-impedance port characteristic.

In some other embodiments of this application, based on the foregoing antenna structures shown in FIG. 6A to FIG. 16, further optimization design may be performed, to obtain better radiation performance.

For example, in some embodiments, the antenna structure shown in FIG. 8 is used as an example, and the radiator 41 may be split into a plurality of radiation units (for example, greater than or equal to two radiation units). The radiators of the plurality of radiation units are disposed in parallel. For example, long sides of the radiators of the plurality of radiation units are disposed at a same straight line. Any two adjacent radiation units of the plurality of radiation units are separated through a slot. A size of the slot may be [0.1 mm to 5 mm]. Corresponding to the radiator 41, a total length of the plurality of radiation units is less than ½ wavelength of the operating frequency band. Both ends of each radiation unit are connected to the common mode feed structure in the foregoing embodiment respectively.

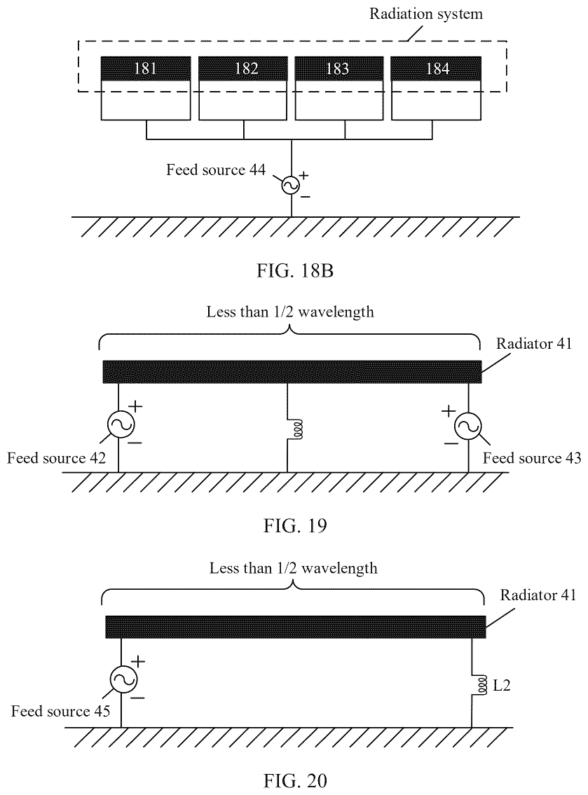

For example, an example in which the radiator 41 is split into four radiation units, and the common mode feed structure includes one feed source (for example, the feed source 44) as shown in FIG. 17 is used. FIG. 18A is a schematic diagram of still yet another antenna solution according to an embodiment of this application. In this example, the radiation unit may include a radiator 181, a radiator 182, a radiator 183, and a radiator 184. Long sides of the radiator 181, the radiator 182, the radiator 183, and the radiator 184 are disposed at a same straight line, and a total length is less than ½ wavelength of an operating frequency band. As shown in FIG. 18A, two ends of the radiator 181, the radiator 182, the radiator 183, and the radiator 184 may be connected to one end (for example, a positive electrode) of a feed source 44 respectively. Another end (for example, a negative electrode) of the feed source 44 is grounded.

In this way, common mode feed of each radiation unit is implemented. In some implementations, a match circuit may also be disposed at a link between each radiation unit and the feed source, to match a low-impedance port characteristic of a feed signal.

It should be noted that, in a feed form provided in FIG. 18A, a 1-for-8 split form at both ends of the feed source and each radiation unit is used as an example to describe the feed signal. In some other embodiments, the split form of the feed signal may alternatively be a two-level or multilevel split form, to implement the common mode feed of the radiation units. For example, as shown in FIG. 18B, in this example, an example in which the feed signal implement signal flow through the two-level split between the feed source and the radiation units is used. As shown in FIG. 18B, after the feed signal flows out of the feed source 44, the feed signal may be divided into four feed signals of equal amplitude and in phase through a first-level split. Each of the four feed signals of equal amplitude and in phase may be further divided into two feed signals of equal amplitude and in phase through the two-level split respectively. Therefore, after the two-level split, eight feed signals of equal amplitude and in phase are obtained and connected to the eight ends of the radiation unit 181 to the radiator 184 respectively, to implement the common mode feed of the radiation units.

It may be understood that, with reference to the schematic descriptions of FIG. 8, after the radiator 41 is split into the plurality of radiation units, a low-impedance common mode feed is connected to each radiation unit, so that a smaller maximum electric field amplitude difference is obtained between each radiation unit and the reference ground. Therefore, when the antenna formed by the plurality of radiation units is in operation, a maximum electric field amplitude difference between the radiator of the antenna and the reference ground is smaller. Therefore, the radiation performance is significantly improved. Based on the descriptions, a larger quantity of radiation units obtained by splitting indicates a corresponding upgrading effect.

It should be noted that, in the solution example shown in FIG. 18A, when a slot between adjacent radiation units is small (for example, a size of the slot is within 0.1 mm and 5 mm), the plurality of radiation units may jointly form a radiation system. Correspondingly, the operating frequency band of the radiation system is related to a total length of the plurality of radiation units.

In some embodiments, an example in which the radiation system includes four radiators disposed end to end through slots as shown in FIG. 18A is used. A total length of the radiator system may be less than ½ wavelength of the operating frequency band. In this way, even after the slot is opened, a total electrical length of the radiation system is reduced, and compensation may be performed by using the match circuit disposed between the feed source and the radiator, so that excited resonance is tuned to a position corresponding to the operating frequency band.

In some other embodiments, the total length of the radiation system may also be greater than or equal to ½ wavelength. In this way, based on a reason similar to the foregoing descriptions with reference to FIG. 18A, the maximum electric field amplitude difference in the space between the radiating system and the reference ground is reduced by dividing and arranging the plurality of radiation units, so that the radiation performance of an entire antenna is improved.

In some other embodiments of this application, the foregoing objectives may also be implemented in other manners.

For example, at least one inductance may be connected in parallel on a radiator having a length less than ½ wavelength of the operating frequency band. Based on a magnetic energy characteristic of the inductance, a close magnetic flow can be generated near the antenna radiator provided with a parallel inductance. Because of an electromagnetic correlation, a same-direction electric field distribution with a small intensity difference can be generated in a space corresponding to a closed magnetic flow. In this way, by disposing at least one parallel inductance in the radiator, a maximum electric field amplitude difference at different positions in the space between the radiator and the reference ground is further reduced, so that better radiation performance is obtained.

For example, FIG. 19 is a schematic diagram of still yet another antenna solution according to an embodiment of this application. An example in which transformation is performed based on the antenna solution shown in FIG. 8, and an inductance (such as L1) is connected in parallel at a radiator is used. One end of the inductance is connected at a middle position of the radiator, and another end of the inductance is grounded.

As shown in FIG. 19, in the antenna solution, an antenna radiator may be a radiator 41 with a length less than ½ wavelength of an operating frequency band. Both ends of the radiator 41 may be connected to a common mode feed structure (such as the feed source 42 and the feed source 43 shown in FIG. 8) respectively. In this example, the inductance L1 connected in parallel to the ground may further be disposed at the radiator 41 between two ends that are connected to the feed source 42 and the feed source 43. For example, one end of the inductance L1 may be disposed at a middle position of the radiator 41, and another end of the inductance L1 may be grounded. Based on the foregoing principle descriptions, after the inductance L1 is disposed, a maximum electric field amplitude difference between the radiator 41 and a reference ground when the antenna is in operation can be further reduced, and radiation performance is improved.

Similar to the foregoing descriptions of FIG. 18A, in the example of FIG. 19, when a length of the radiator is equal to or greater than ½ wavelength, the maximum electric field amplitude difference between the radiator and the reference ground can also be reduced by adding the inductance connected in parallel to the ground, so that the radiation performance is improved.

As still another possible implementation, as shown in FIG. 20, based on the solution shown in FIG. 19, the grounded inductance may alternatively be disposed at any end of the radiator 41, to replace an end low-impedance feed source. In this way, the antenna may include a feed source 45 disposed at one end, and a grounded inductance L2 disposed at another end. Because of a magnetic energy storage characteristic of the inductance L2, in a region between the radiator 41 and the reference ground, the maximum electric field amplitude difference is reduced and approximately evenly distributed, so that the radiation performance is improved.

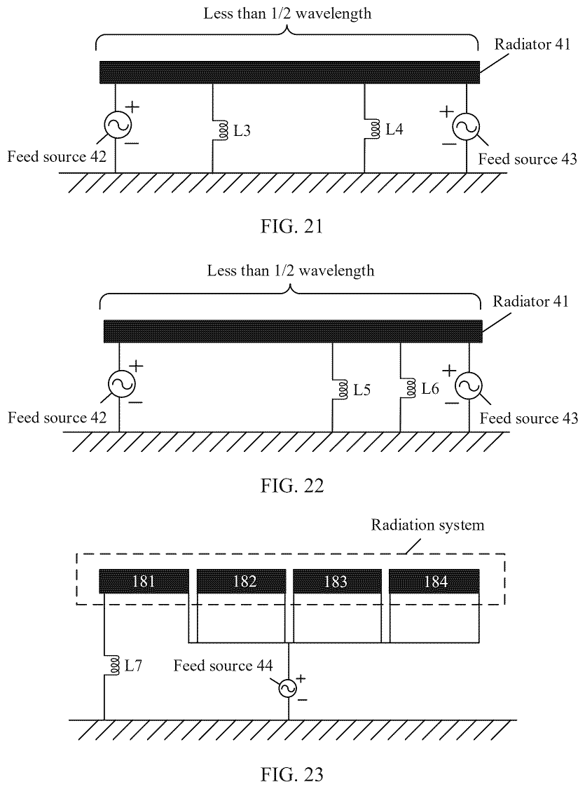

It may be understood that, in an example such as FIG. 19 or FIG. 20, an inductance is schematically connected in parallel on the radiator as an example for description. In some other implementations, two or more inductances may alternatively be connected in parallel on the radiator. For example, a larger quantity of parallel inductances disposed at the radiator 41 indicates a smaller maximum electric field amplitude difference in a space near the radiator 41, and indicates better radiation performance of the corresponding antenna. FIG. 21 is an example of a solution in which more inductances are connected in parallel on the radiator. An inductance L3 and an inductance L4 are connected in parallel on the radiator as an example. Both the inductance L3 and the inductance L4 have an end grounded, and another end may be coupled to a radiator 41. Positions at which the inductance L3 and the inductance L4 are coupled to the radiator 41 may be between two feed points to which a feed source 42 and a feed source 43 are coupled. In this way, because of disposing of more inductances, the maximum electric field amplitude difference between the radiator 41 and the reference ground is further reduced, so that radiation performance is improved.

In some embodiments, as shown in FIG. 21, positions of the inductance L3 and the inductance L4 may be symmetrical about an axis of the radiator 41 as shown in FIG. 21. In some other embodiments, as shown in FIG. 22, positions of an inductance L5 and an inductance L6 connected in parallel may either not have any symmetric feature. Positions of different inductances can all be set based on the magnetic energy storage characteristic of the inductance, so that the maximum electric field amplitude difference in a space is reduced, so that overall radiation performance is improved.

In addition, similar to the foregoing descriptions of FIG. 19, when the length of the radiator is equal to or greater than ½ wavelength, the maximum electric field amplitude difference between the radiator and the reference ground can also be further reduced by adding a plurality of inductances connected in parallel to the ground, so that the radiation performance is improved.

FIG. 18A to FIG. 22 respectively describes the optimized designs of the solution provided in embodiments of this application from a perspective of dividing the plurality of radiation units and a perspective of adding the grounded inductance. In some other embodiments of this application, the technical means of dividing the plurality of radiation units and adding the grounded inductance may also be used in combination, so that the radiation performance of the antenna is improved.

For example, in some embodiments, refer to FIG. 23. An example in which the radiator is divided into four radiation units as shown in FIG. 18A is used. Two ends of a radiator 182, a radiator 183, and a radiator 184 may be connected to feed signals of equal amplitude and in phase respectively. For example, two ends of the radiator 182 are respectively coupled to a positive electrode of a feed source 44. Two ends of the radiator 183 are respectively coupled to the positive electrode of the feed source 44. Two ends of the radiator 184 are respectively coupled to the positive electrode of the feed source 44. One end (a right end as shown in FIG. 23) of the radiator 181 may be coupled to the positive electrode of the feed source 44. Another end (a left end as shown in FIG. 23) of the radiator 181 may be grounded through an inductance L7. In this way, based on a magnetic energy storage characteristic of the inductance L7, a maximum electric field amplitude difference in the space between the radiator 181 and a reference ground can also be reduced, and overall radiation performance is improved. It is cleared that, in some other embodiments, the grounded inductance L7 may also be disposed at any end of the radiator 182, the radiator 183, and/or the radiator 184. Effects thereof can be similar, and is not described again.

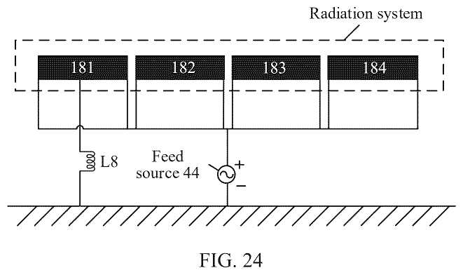

In some embodiments, refer to FIG. 24. An example in which the radiator is divided into four radiation units as shown in FIG. 18A is used. Two ends of a radiator 181, a radiator 182, a radiator 183, and a radiator 184 may be connected to feed signals of equal amplitude and in phase respectively. In this example, one end of an inductance L8 may further be connected between two ends of the radiator 181. Another end of the inductance L8 may be grounded. In this way, with reference to the descriptions of FIG. 19, based on a magnetic energy storage characteristic of the inductance L8, a maximum electric field amplitude difference between the radiator 181 and a reference ground can be further reduced, so that radiation performance is improved. It is cleared that, in some other embodiments, the grounded inductance may also be disposed at a position corresponding to another radiator unit, and/or a quantity of the grounded inductance may be two or more. Effects thereof may refer to the foregoing descriptions, and is not described herein again.

It may be understood that, although this application is described with reference to specific features and embodiments thereof, it is clear that various modifications and combinations can be made to them without departing from the spirit and scope of this application. Correspondingly, this specification and the accompanying drawings are merely used as examples of descriptions of this application defined by the appended claims, and are considered as having covered any of and all of modifications, variations, combinations, or equivalents within the scope of this application. It is clear that, a person skilled in the art can make various modifications and variations to this application without departing from the spirit and scope of this application. In this case, if the modifications and variations made to this application fall within the scope of the claims of this application and their equivalent technologies, this application is intended to include these modifications and variations.

1. A terminal antenna, wherein the antenna is used in an electronic device;
the antenna comprises a first radiator, a length of the first radiator is less than a first value, and the first value corresponds to ½ wavelength of an operating frequency of the antenna; and
a first feed point and a second feed point are disposed at two ends of the first radiator respectively, the first feed point and the second feed point are connected to two signal output ends of a common mode feed structure respectively, the two signal output ends have a same polarity, and the two signals are signals of equal amplitude and in phase.

2. The antenna according to claim 1, wherein the length of the first radiator is less than or equal to ¼ wavelength of the operating frequency.

3. The antenna according to claim 1, wherein the length of the first radiator is less than or equal to ⅛ wavelength of the operating frequency.

4. The antenna according to claim 1, wherein
the common mode feed structure comprises a first feed source and a second feed source;
a first electrode of the first feed source is coupled to the first feed point, and a first electrode of the second feed source is coupled to the second feed point; and
the first electrode is a positive electrode, or the first electrode is a negative electrode.

5. The antenna according to claim 1, wherein
the common mode feed structure comprises a third feed source; and
a first electrode of the third feed source is coupled to the first feed point and the second feed point respectively.

6. The antenna according to claim 1, wherein a feed signal outputted by the common mode feed structure and then inputted to the first radiator has a low-impedance port characteristic.

7. The antenna according to claim 1, wherein
a match circuit is disposed between the common mode feed structure and the first radiator, and the match circuit is configured to adjust an impedance of the feed signal outputted by the common mode feed structure to the low-impedance port characteristic.

8. The antenna according to claim 1, wherein when the antenna is in operation, the antenna operates in a 0.5 time wavelength mode.

9. The antenna according to claim 1, wherein
when the antenna is in operation, a maximum electric field amplitude difference between the first radiator and a reference ground is less than a second value, and the second value is the maximum electric field amplitude difference between the first radiator and the reference ground corresponding to a case when the length of the first radiator is replaced with the first value.

10. The antenna according to claim 1, wherein
the first radiator is in a stripe shape, and a straight line on which a long side of the first radiator is located is parallel to the reference ground.

11. The antenna according to claim 1, wherein the first radiator comprises a second part, a first part, and a third part that are connected in sequence; and
the second part is perpendicular to the reference ground, the third part is perpendicular to the reference ground, and the first part is disposed between the second part and the third part.

12. The antenna according to claim 10, wherein a first slot is disposed at a middle position of the first radiator, and the first slot divides the first radiator into two parts that are not connected to each other.

13. The antenna according to claim 1, wherein
the first radiator is divided into at least two radiation units by at least one second slot;
two ends of each radiation unit are connected to the two signal output ends of the common mode feed structure respectively; or
one end of any one or more first radiation units is grounded through an inductance, another end of the first radiation unit is coupled to the feed source, and the first radiation unit is comprised in the at least two radiation units; and
when a quantity of first radiation units is less than the at least two radiation units, two ends of a second radiation unit are connected to the two signal output ends of the common mode feed structure respectively, and the second radiation unit corresponds to each radiation unit that is of the at least two radiation units and that is different from the first radiation unit.

14. The antenna according to claim 13, wherein a size of the second slot is comprised in a range of [0.1 mm, 5 mm].

15. The antenna according to claim 1, wherein at least one inductance is disposed in parallel at the first radiator; and
when a plurality of inductances are connected in parallel at the first radiator, at least part of the first radiator is comprised between any two of the inductances.

16. A terminal antenna, wherein the antenna is used in an electronic device;
the antenna comprises a reference ground and a third slot opened on the reference ground, a length of the third slot is less than a first value, and the first value corresponds to ½ wavelength of an operating frequency of the antenna;
two ends of the third slot are a first end and a second end respectively, the first end comprises a first electrical connection point and a second electrical connection point, the second end comprises a third electrical connection point and a fourth electrical connection point, the first electrical connection point and the third electrical connection point are located at a same side of a long side of the third slot, and the second electrical connection point and the fourth electrical connection point are located at the other side of the long side of the third slot; and
a third feed source is connected between the first electrical connection point and the second electrical connection point, a fourth feed source is connected between the third electrical connection point and the fourth electrical connection point, a signal inputted into the first electrical connection point by the third feed source is a first signal, a signal inputted into the third electrical connection point by the fourth feed source is a second signal, and the first signal and the second signal are signals of equal amplitude and in phase.

17. The antenna according to claim 16, wherein the length of the third slot is less than or equal to ¼ wavelength of the operating frequency.

18. The antenna according to claim 16, wherein the length of the third slot is less than or equal to ⅛ wavelength of the operating frequency.

19. The antenna according to claim 16, wherein
the second electrical connection point and the fourth electrical connection point are reference grounds of the third feed source and the fourth feed source respectively.

20. A terminal antenna, wherein
the antenna comprises a first radiator, a length of the first radiator is a first value, and the first value corresponds to ½ wavelength of an operating frequency of the antenna; and
a first feed point and a second feed point are disposed at two ends of the first radiator respectively, the first feed point and the second feed point are connected to two signal output ends of a common mode feed structure respectively, the two signal output ends have a same polarity, and the two signals are signals of equal amplitude and in phase.

21-22. (canceled)
